(19) United States
(12) Patent Application Publication
(10) Pub. No.: US 2017/0206178 A1
(43) Pub. Date: Jul. 20, 2017

(54) INFORMATION PROCESSING APPARATUS, METHOD OF TRANSFERRING DATA, AND NON-TRANSITORY COMPUTER-READABLE RECORDING MEDIUM

(71) Applicant: FUJITSU LIMITED, Kawasaki-shi (JP)

(72) Inventor: Yuichi Ogawa, Kawasaki (JP)

(73) Assignee: FUJITSU LIMITED, Kawasaki-shi (JP)

(21) Appl. No.: 15/359,798

(22) Filed: Nov. 23, 2016

(30) Foreign Application Priority Data
Jan. 20, 2016 (JP) 2016-008394

(51) Int. Cl. G06F 13/28; G06F 3/06; G06F 12/0895; G06F 13/40

(52) U.S. Cl. CPC G06F 13/28; G06F 13/4068; G06F 3/061; G06F 3/0647; G06F 3/0683; G06F 12/0895; G06F 2212/60

(57) ABSTRACT

An information processing apparatus includes a first memory, a data transfer circuit, and a processor, wherein the first memory is configured to store a first read instruction to read second data stored in a second memory, the processor is configured to generate a first write instruction to write first data stored in the first memory into the second memory and a second read instruction to read the first read instruction stored in the first memory, and the data transfer circuit is configured to write the first data into the second memory based on the first write instruction, read, after the first data is written, the second data from the second memory by executing the first read instruction stored in the first memory based on the second read instruction, and transmit, after the second data is read, to the processor a notification indicating that the second data has been read.

### CROSS-REFERENCE TO RELATED APPLICATION

This application is based upon and claims the benefit of priority of the prior Japanese Patent Application No. 2016-008394, filed on Jan. 20, 2016, the entire contents of which are incorporated herein by reference.

### FIELD

The embodiments discussed herein are related to an information processing apparatus, a method of transferring data, and a non-transitory computer-readable recording medium.

### BACKGROUND

Direct memory access (DMA) is one of the methods of transferring data in a computer system. In a system which employs DMA, a DMA controller directly transfers data between storage devices independently of a central processing unit (CPU) when the CPU instructs the DMA controller to transfer the data. This reduces processing load of the CPU and thereby improves processing efficiency of the entire system.

As an example of a system which employs DMA, a system is proposed in which: a CPU generates descriptor information and stores the thus-generated descriptor information in a descriptor storage unit; and then, a controller in a hard disk drive (HDD) reads the descriptor information from the descriptor storage unit and executes DMA transfer between a memory and the HDD in accordance with the descriptor information.

As a technique of ensuring data backup, the following system is proposed. In the system, a first device stores data and transmits the data to a second device. The second device stores the data received from the first device, and transmits the data to the first device. The first device compares the data transmitted to the second device and the data received from the second device and transmits the former data again in the case where there is a mismatch between the former transmitted data and the received data. Japanese Laid-open Patent Publication Nos. 2007-241588 and 2005-182251 are examples of the related art.

### SUMMARY

According to an aspect of the invention, an information processing apparatus includes a first memory, a data transfer circuit, and a processor coupled to the memory and the data transfer circuit, wherein the first memory is configured to store a first read instruction to read second data stored in a second memory, the processor is configured to generate a first write instruction to write first data stored in the first memory into the second memory and a second read instruction to read the first read instruction stored in the first memory, and the data transfer circuit is configured to write the first data into the second memory based on the first write instruction, read, after the first data is written, the second data from the second memory by executing the first read instruction stored in the first memory based on the second read instruction, and transmit, after the second data is read, to the processor a notification indicating that the second data has been read.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example and a processing example of a storage controller according to a first embodiment;

FIG. 2 is a diagram illustrating a configuration example of a storage system according to a second embodiment;

FIG. 3 is a diagram illustrating a hardware configuration example of CMs and an FRT;

FIG. 4 is a diagram illustrating an internal configuration example of a DMA controller;

FIG. 5 is a diagram for explaining descriptors;

FIG. 6 is a sequence diagram illustrating an example of basic procedures of data transfer processing by the DMA controller;

FIG. 7 is a sequence diagram (Part 1) illustrating a comparative example of write processing procedures with dummy read;

FIG. 8 is a sequence diagram (Part 2) illustrating the comparative example of the write processing procedures with the dummy read;

FIG. 9 is a diagram illustrating an example of creating the descriptors in a case where a host write is successively requested;

FIG. 10 is a diagram for explaining how the dummy read is executed in a second embodiment;

FIG. 11 is a diagram illustrating an example of creating the descriptors in a case where the host write is successively requested in the second embodiment;

FIG. 12 is a sequence diagram (Part 1) illustrating an example of processing procedures in a case where the host write is requested;

FIG. 13 is a sequence diagram (Part 2) illustrating the example of the processing procedures in a case where the host write is requested;

FIG. 14 is a flowchart illustrating an example of initialization processing of the DMA controller;

FIG. 15 is a flowchart illustrating an example of processing of a CPU in a case where the host write is requested; and

FIG. 16 is a flowchart illustrating an example of processing of the DMA controller.

### DESCRIPTION OF EMBODIMENTS

Processing is assumed in which a DMA controller writes data in a first storage device onto a second storage device based on descriptors created by a CPU. In this case, a possible way to check whether or not the data has been received by the second storage device is to read and compare the data after the data is written onto the second storage device.

In order to read data for comparison after writing of the data as described above, the CPU creates a descriptor for writing the data and a descriptor for reading the data for comparison. In the case where the data for comparison is read each time the data is written, these two descriptors are repeatedly generated.

However, when the descriptors for checking the reception of data are repeatedly generated each time the data is written, there arises a problem of deteriorating processing efficiency of the CPU. Moreover, there might be a case where it takes long for the data for comparison to be read because each time the data is written, the data for comparison with the same size as that of the written data is read. This leads to the deterioration of the efficiency of the entire processing to check whether or not the data has been received.

Hereinbelow, embodiments of the disclosure will be described with reference to the drawings.

### First Embodiment

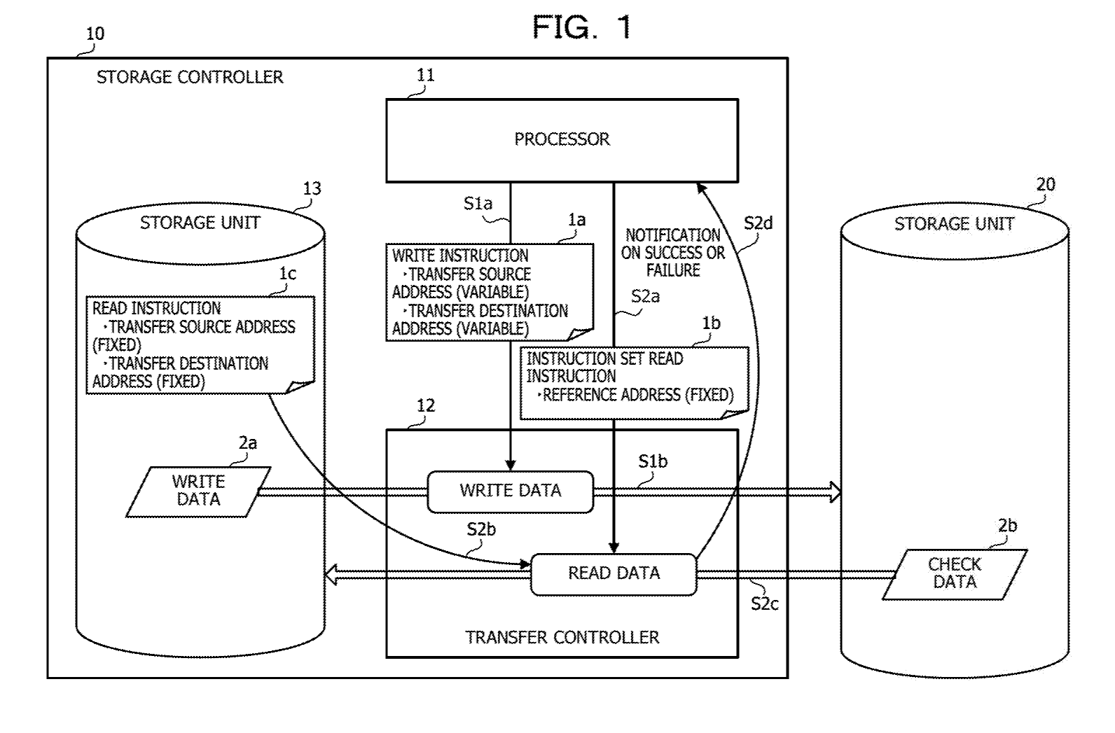

FIG. 1 is a diagram illustrating a configuration example and a processing example of a storage controller according to a first embodiment. A storage controller 10 illustrated in FIG. 1 includes a processor 11, a transfer controller 12, and a storage unit 13.

The processor 11 instructs the transfer controller 12 to write data onto a storage unit 20 and to read the data from the storage unit 20. The transfer controller 12 is implemented as, for example, a control circuit or an arithmetic circuit separate from the processor 11. The transfer controller 12 writes data onto the storage unit 20 and reads the data from the storage unit 20 based on the instruction from the processor 11. Data is written onto the storage unit 20 and is read from the storage unit 20 by the operation of the transfer controller 12 without involving the processor 11.

In FIG. 1, the storage unit 20 targeted for read and write control by the transfer controller 12 is disposed outside the storage controller 10, for example. However, the storage unit 20 may be installed inside the storage controller 10. In addition, in FIG. 1, the transfer controller 12 is assumed to control data transfer between the storage unit 20 and the storage unit 13 included in the storage controller 10, for example. The storage units 13 and 20 are implemented as a storage device such as a random access memory (RAM), for example.

An instruction set 1c is stored in the storage unit 13 in advance. As described later, the instruction set 1c includes information for causing the transfer controller 12 to read check data 2b.

Here, the processor 11 causes the transfer controller 12 to write data onto the storage unit 20, and then causes the transfer controller 12 to execute read processing for checking whether or not the data has been received by the storage unit 20. In the read processing for check, the check data 2b stored in the storage unit 20 is read. The check data 2b is different from the write data written onto the storage unit 20 and is stored in a predetermined position inside the storage unit 20.

After the write data is written onto the storage unit 20 by the transfer controller 12, the same check data 2b is read by the transfer controller 12 regardless of the write destination of the write data. When the check data 2b is successfully read, at least the circuit on the path from the transfer controller 12 to the storage unit 20 is in normal operation. Thus, it is highly possible that the writing of data onto the storage unit 20 executed immediately before the read was executed normally.

As described above, a method of reading the check data 2b to check the reception of data makes it possible to suppress the size of the data to be read to a certain size or less, compared to verify read processing which reads the write data immediately after the write data is written onto the storage unit 20. Accordingly, it is possible to reduce the processing load for checking the reception and to shorten the processing time thereof.

Hereinbelow, description will be provided in detail for processing which includes writing of data onto the storage unit 20 and checking the reception of the data.

First, the processor 11 instructs the transfer controller 12 to write data for writing (write data) 2a from the storage unit 13 onto the storage unit 20 (Step S1a). The processor 11 issues this write instruction by creating and outputting an instruction set 1a, for example. The instruction set 1a includes a write instruction for instructing write, a transfer source address which indicates the position of the write data 2a in the storage unit 13, and a transfer destination address which indicates the write destination of the write data 2a in the storage unit 20. Note that the positions of the transfer source and the transfer destination of the write data 2a may be any positions. Thus, the transfer source address and the transfer destination address included in the instruction set 1a are variable.

The transfer controller 12 refers to the thus-outputted instruction set 1a, reads the write data 2a from the storage unit 13 based on the transfer source address, and writes the write data 2a onto the storage unit 20 based on the transfer destination address (Step S1b).

Subsequently, the processor 11 instructs the transfer controller 12 to read the check data 2b. The read instruction is performed in a way that the processor 11 creates an instruction set 1b and outputs the thus-created instruction set 1b (Step S2a). Note that after the instruction set 1a is outputted, the processor 11 may output the instruction set 1b without waiting the start of execution to write the write data 2a or the completion thereof.

As illustrated in FIG. 1, the instruction set 1b includes a reference address which indicates the position of the instruction set 1c in the storage unit 13, and a read instruction for instructing read from the reference address, for example. Since the instruction set 1c is used in a shared manner for checking success or failure after two or more write instructions, the reference address included in the instruction set 1b is a fixed value.

The transfer controller 12 reads the instruction set 1c from the storage unit 13 based on the outputted instruction set 1b (Step S2b). In the example of FIG. 1, the transfer controller 12 reads the instruction set 1c from the storage unit 13 based on the reference address included in the instruction set 1b.

The instruction set 1c includes information for reading the check data 2b from the predetermined position in the storage unit 20. For example, the instruction set 1c includes a read instruction for instructing read, a transfer source address which indicates the position of the check data 2b in the storage unit 20, and a transfer destination address which indicates the write destination of the check data 2b in the storage unit 13. Note that the transfer source address and the transfer destination address included in the instruction set 1c are each a fixed value.

The transfer controller 12 reads the check data 2b from the storage unit 20 based on the read instruction set 1c (Step S2c). In the example of FIG. 1, the transfer controller 12 reads the check data 2b from the storage unit 20 based on the transfer source address included in the instruction set 1c, and writes the check data 2b onto the storage unit 13 based on the transfer destination address.

The transfer controller 12 determines whether or not the check data 2b has been successfully read, and notifies the processor 11 of the result (Step S2d). The processor 11 determines that the write data 2a was successfully written if the processor 11 is notified that the check data 2b has been successfully read.

Here, as a method of causing the transfer controller 12 to read the check data 2b, one may consider, for example, that the processor 11 creates the instruction set 1c for the read and outputs the thus-created instruction set 1c to the transfer controller 12. However, the read source of the check data 2b is consistently the same, and its read destination may also be the same. Thus, the created instruction sets 1c may consistently have the same content as well. The creating of the instruction set 1c with the same content as above for each instruction to write the write data onto the storage unit 20 is wasteful processing and deteriorates the processing efficiency of the processor 11.

In the storage controller 10 according to the embodiment, on the other hand, the instruction set 1c with the same content as above is created in advance and stored in the storage unit 13. Then, the processor 11 creates the instruction set 1b for instructing read of the instruction set 1c and outputs the thus-created instruction set 1b, and thereby instructs the transfer controller 12 to read the check data 2b. The transfer controller 12 reads the instruction set 1c based on the thus-outputted instruction set 1b, and reads the check data 2b from the storage unit 20 based on the instruction set 1c.

Since the instruction set 1b created by the processor 11 has only to include the content for reading the instruction set 1c stored in a fixed position on the storage unit 13, it is possible to make the content of the instruction set 1b simpler than that of the instruction set 1c for instructing data transfer between the storage units. Accordingly, the data size of the instruction set 1b may be made smaller than that of the instruction set 1c. For example, the instruction set 1b may include only one address indicating the reference address, while the instruction set 1c includes two addresses, namely, the transfer source address and the transfer destination address. In addition, in the case where the check data 2b is stored in the storage unit 20 outside the device as in the example of FIG. 1, a physical address is set as the transfer source address in the instruction set 1c. On the other hand, the instruction set 1c is stored in a fixed position in a local storage unit inside the device. Thus, it is possible to reduce in various ways the number of bits of the reference address which is included in the instruction set 1b to designate the position of the instruction set 1c.

According to the storage controller 10 of the embodiment as described above, the size of the instruction set 1b created by the processor 11 to instruct the read of the check data 2b may be made small. As a result, it is possible to shorten the processing time of the processor 11 taken to instruct the read of the check data 2b, and to reduce the processing load thereof.

As has been described above, according to the storage controller 10 of the embodiment, it is possible to stably make small the size of the data to be read for checking the reception of the write data. Moreover, the size of the instruction set 1b for instructing the read of the check data 2b may also be made small. This makes it possible to reduce the processing load for checking the reception of the write data and to shorten the processing time.

### Second Embodiment

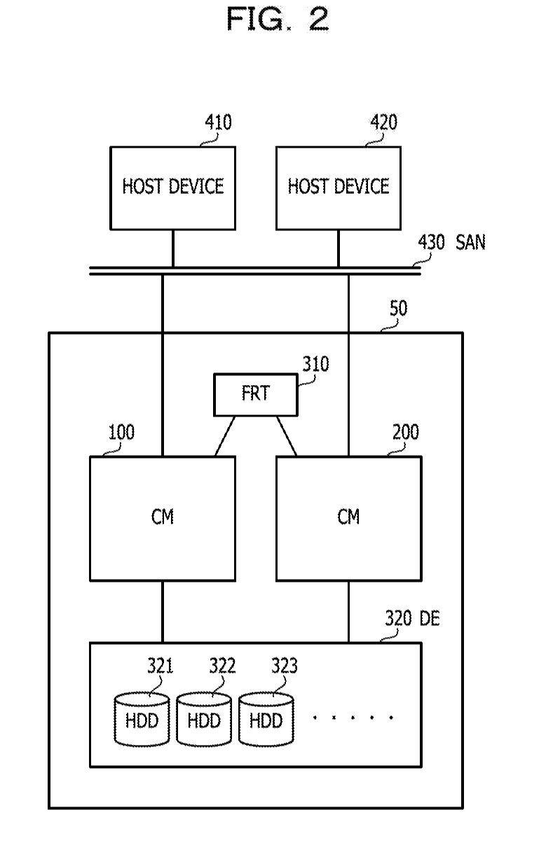

FIG. 2 is a diagram illustrating a configuration example of a storage system according to a second embodiment. A storage system 50 illustrated in FIG. 2 includes controller modules (CMs) 100 and 200, a fronted router (FRT) 310, and a drive enclosure (DE) 320. In addition, host devices 410 and 420 are coupled to the CMs 100 and 200 via a storage area network (SAN) 430.

The CMs 100 and 200 are each a storage controller which controls access to storage devices installed in the DE 320 in response to a request from the host device 410 or the host device 420. The CM 100 controls access to the storage devices inside the DE 320 using a cache in the CM 100. Likewise, the CM 200 controls access to the storage devices inside the DE 320 using a cache in the CM 200.

Besides, the CM 100 and the CM 200 are coupled to each other via the FRT 310, and are capable of transmitting and receiving data to and from each other. In particular, a DMA controller, which is provided to each of the CM 100 and the CM 200, enables data transfer between the CM 100 and the CM 200, in other words, from a RAM provided to one of the CM 100 and the CM 200 to a RAM provided to the other, as described later.

Data transfer between RAMs via the FRT 310 as above is used in cache mirroring, for example. One of the CMs 100 and 200 is set in an operating state and the other is set in a standby state, for example. The CM in the operating state writes cache data inside thereof onto a mirroring area in the other CM via the FRT 310, thereby duplicating the cache data. Thus, when the CM in the operating state stops abnormally, the other CM transitions to the operating state and is allowed to take over access control to the storage devices inside the DE 320.

Note that in the following explanation, the processing of writing data from the host device 410 or the host device 420 onto the DE 320 via the CM 100 or the CM 200 may be described as a “host write”. Additionally, the writing of data from the RAM of the CM 100 to the RAM of the CM 200 or the writing of data in the reverse direction may be described as “inter-CM write” with the intention of making a differentiation from the “host write”.

Two or more storage devices to be targeted for access from the host devices 410 and 420 are installed to the DE 320. In the embodiment, for example, assume that the DE 320 is a disk array device to which HDDs 321, 322, 323, . . . are installed as the storage devices above. Note that each of the storage devices to be targeted for access from the host devices 410 and 420 may be a non-volatile storage device of a different type such as a solid state drive (SSD).

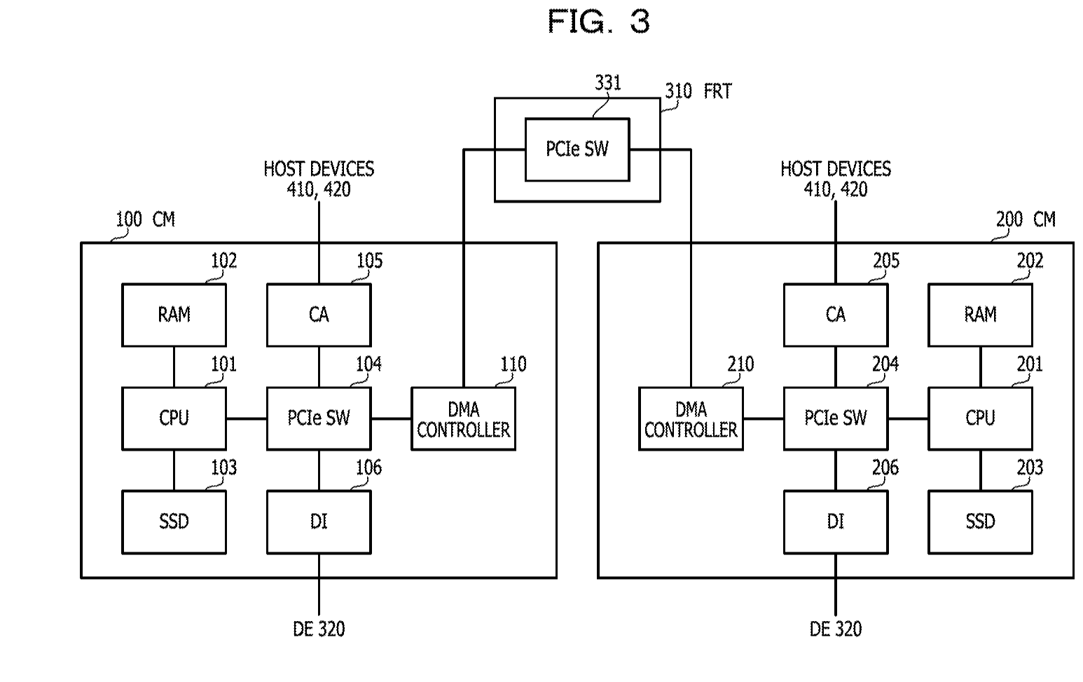

FIG. 3 is a diagram illustrating a hardware configuration example of the CMs and the FRT.

The CM 100 includes a CPU 101, a RAM 102, an SSD 103, a peripheral component interconnect express (PCIe) switch (SW) 104, a channel adapter (CA) 105, a drive interface (DI) 106, and a DMA controller 110.

The CPU 101 controls the entire CM 100 in a unified manner. For example, the CPU 101 is provided with one or more processors. Besides, although not illustrated, the CPU 101 is provided with a memory controller. The memory controller enables read and write by the DMA controller 110 from and to the RAM 102 without involving the processor of the CPU 101.

The RAM 102 is used as a main storage device of the CM 100. At least part of an operating system (OS) program and an application program to be executed by the CPU 101 is temporarily stored in the RAM 102. In addition, various types of data requested for processing by the CPU 101 are stored in the RAM 102. For example, a cache area, which is used for access control to the storage devices inside the DE 320 in response to requests from the host devices 410 and 420, is allocated in the RAM 102.

The SSD 103 is used as an auxiliary storage device of the CM 100. The OS program, the application program, and the various types of data are stored in the SSD 103. Note that a non-volatile storage device of a different type such as an HDD may be used as the auxiliary storage device. Moreover, the SSD 103 may be coupled to the CPU 101 via a chipset or the like to which a bus controller is installed.

The CPU 101 and each of the CA 105, the DI 106, and the DMA controller 110 are coupled through a PCIe bus via the PCIe switch 104. The PCIe switch 104 controls transmission and reception of data between the CPU 101 and each of the CA 105, the DI 106, and the DMA controller 110.

The CA 105 is an interface for communicating with the host devices 410 and 420 via the SAN 430. The CA 105 is a fibre channel (FC) interface, for example. The DI 106 is an interface for communicating with the storage devices inside the DE 320. The DI 106 is a serial attached small computer system interface (SAS) interface, for example.

The DMA controller 110 controls data transfer between the RAM 102 and a RAM 202 in the CM 200 on the other side. As described later, the DMA controller 110 controls the data transfer between the RAM 102 and the RAM 202 in accordance with the content of the descriptors created by the CPU 101.

The CM 200 has the same hardware configuration as that of the CM 100. The CM 200 includes a CPU 201, the RAM 202, an SSD 203, a PCIe switch (SW) 204, a CA 205, a DI 206, and a DMA controller 210. The CPU 201, the RAM 202, the SSD 203, the PCIe switch 204, the CA 205, the DI 206, and the DMA controller 210 are components corresponding to the CPU 101, the RAM 102, the SSD 103, the PCIe switch 104, the CA 105, the DI 106, and the DMA controller 110, respectively, and thus the description thereof is omitted here.

The FRT 310 includes a PCIe switch (SW) 331. The PCIe switch 331 is coupled to the DMA controller 110 of the CM 100 and the DMA controller 210 of the CM 200. By way of the DMA controller 110, the PCIe switch 331, and the DMA controller 210, the data transfer between the RAM 102 of the CM 100 and the RAM 202 of the CM 200 is executed without involving the CPUs 101 and 201.

In the above configuration, the CMs 100 and 200 are each an example of the storage controller 10 in FIG. 1. When the CM 100 is chosen as an example of the storage controller 10, the CPU 101 is an example of the processor 11 in FIG. 1, the RAMs 102 and 202 are examples of the storage units 13 and 20 in FIG. 1, respectively, and the DMA controller 110 is an example of the transfer controller 12 in FIG. 1.

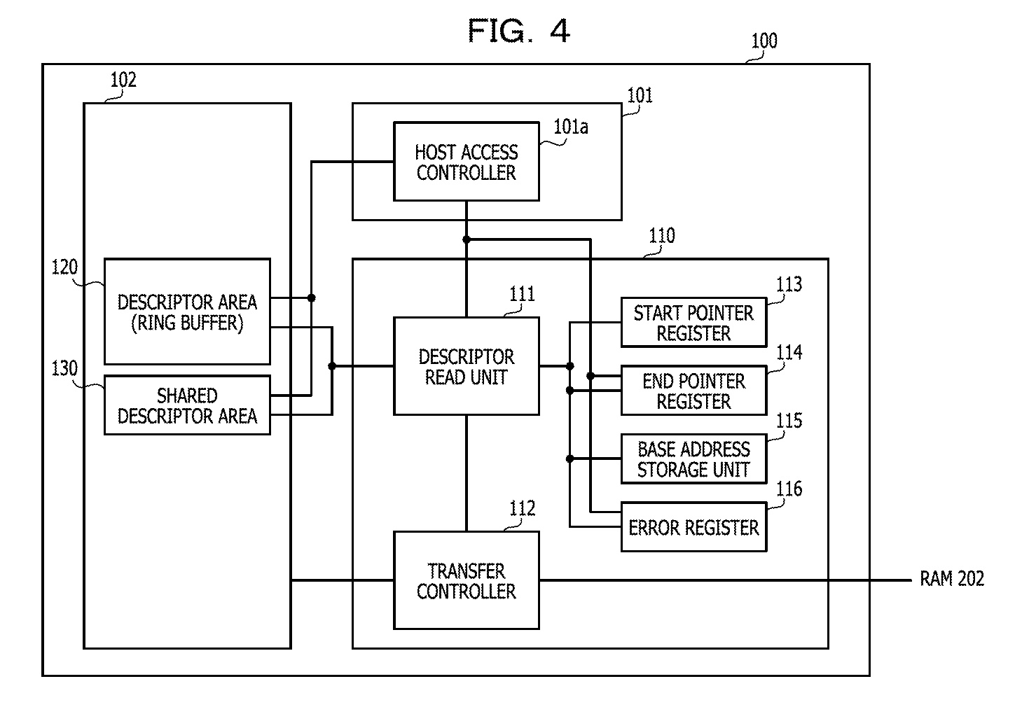

FIG. 4 is a diagram illustrating an internal configuration example of a DMA controller. Note that although FIG. 4 illustrates the internal configuration of the DMA controller 110 of the CM 100, the DMA controller 210 of the CM 200 also has the same internal configuration. Moreover, FIG. 4 illustrates examples of storage areas on the RAM 102 referred to by the DMA controller 110.

The DMA controller 110 includes a descriptor read unit 111, a transfer controller 112, a start pointer register 113, an end pointer register 114, a base address storage unit 115, and an error register 116. Besides, a descriptor area 120 and a shared descriptor area 130 are allocated in the RAM 102.

Two or more descriptors are stored in the descriptor area 120 in the first-in, first-out (FIFO) method. The descriptor area 120 is allocated as a ring buffer, for example. In the descriptors, an instruction set indicating the content of the data transfer processing between the RAMs executed by the DMA controller 110 is described. The descriptors are created by the CPU 101 and then are stored in the descriptor area 120.

In the shared descriptor area 130, a shared descriptor is stored in which the predetermined same content of the data transfer processing (dummy read to be described later) is described. The shared descriptor is rewritable by the CPU 101.

The CPU 101 includes a host access controller 101a. The processing of host access controller 101a is implemented in a way that the CPU 101 executes a predetermined program stored in a storage device such as the SSD 103. The host access controller 101a controls access processing to the DE 320 in response to a request from the host device 410 or the host device 420. During the control, the host access controller 101a uses a cache area (not illustrated) allocated in the RAM 102.

To be more specific, when a host read is requested from the host device 410 and the requested data is stored in the cache area, for example, the host access controller 101a reads the data from the cache area and transmits the data thus read to the host device 410. On the other hand, when the requested data is not stored in the cache area, the host access controller 101a reads the requested data from an HDD inside the DE 320, stores the data thus read in the cache area, and then transmits the data to the host device 410.

Moreover, the host access controller 101a controls the writing of data from the host device 410 or the host device 420 onto the DE 320 in the write-back method. For example, when the host write is requested from the host device 410, the host access controller 101a writes write-data received from the host device 410 onto the cache area of the RAM 102. Furthermore, the host access controller 101a also writes the write-data onto the RAM 202 of the CM 200. The writing of the write-data onto the RAM 202 is executed by requesting the DMA controller 110 to transfer data between the RAMs. After writing the write-data onto the RAM 202, the host access controller 101a transmits a completion response of the host write to the host device 410. At a timing after that, the host access controller 101a writes the write-data written onto the cache area of the RAM 102 onto a corresponding HDD inside the DE 320.

Note that the host access controller 101a is merely an example of a processing function which is implemented by the CPU 101 and requests the DMA controller 110 to transfer data between the RAMs. The CPU 101 may request the DMA controller 110 to transfer data from the RAM 102 to the RAM 202 in the course of processing other than the access processing from the host device 410 or the host device 420 to the DE 320. Meanwhile, the cache area is an example of a transfer source in the data transfer between the RAMs executed by the DMA controller 110. An area of the storage area of the RAM 102 other than the descriptor area 120, the shared descriptor area 130, and the cache area may be designated as the transfer source in the data transfer between the RAMs.

Each of the descriptor read unit 111 and the transfer controller 112 is implemented as a dedicated electronic circuit, for example. In addition, part of the processing of the descriptor read unit 111 and the transfer controller 112 may be implemented in a way that a processor provided to the DMA controller 110 executes predetermined firmware.

The descriptor read unit 111 reads the descriptors in sequence from the descriptor area 120 while referring to the start pointer register 113, the end pointer register 114, and the base address storage unit 115. The start pointer register 113 stores a start pointer which indicates the head position of the storage area for the descriptors of the descriptor area 120 yet to be read. The end pointer register 114 stores an end pointer which indicates the tail position of the storage area for the descriptors of the descriptor area 120 already read. The base address storage unit 115 stores a base address. The start pointer and the end pointer each are represented as a relative address with respect to the base address. The actual address in the descriptor area 120 is calculated by adding the start pointer and the end pointer to the base address.

The descriptor read unit 111 requests the transfer controller 112 to process data transfer based on the read descriptors. The descriptor read unit 111 records information indicating the result of the data transfer processing by the transfer controller 112 in the error register 116.

Note that in the case where the descriptor read unit 111 causes the transfer controller 112 to execute the dummy read to be described later, the descriptor read unit 111 reads the shared descriptor from the shared descriptor area 130 based on the descriptors read from the descriptor area 120. Then, the descriptor read unit 111 requests the transfer controller 112 to execute the dummy read based on the read shared descriptor.

The transfer controller 112 processes data transfer requested by the descriptor read unit 111. The data transfer processing to be executed is roughly divided into the “inter-CM write” in which data read from the RAM 102 of the CM 100 is written onto the RAM 202 of the CM 200, and “inter-CM read” in which data read from the RAM 202 of the CM 200 is written onto the RAM 102 of the CM 100. Via the PCIe switch 331 of the FRT 310, the transfer controller 112 requests the DMA controller 210 of the CM 200 to write data onto the RAM 202 of the CM 200 and to read data from the RAM 202 of the CM 200. This makes it possible to transfer data between the RAM 102 and the RAM 202 without involving the CPUs 101 and 201.

Note that the transfer controller 112 may also write data onto the RAM 102 and read data from the RAM 102 in response to the request from the DMA controller 210 of the CM 200.

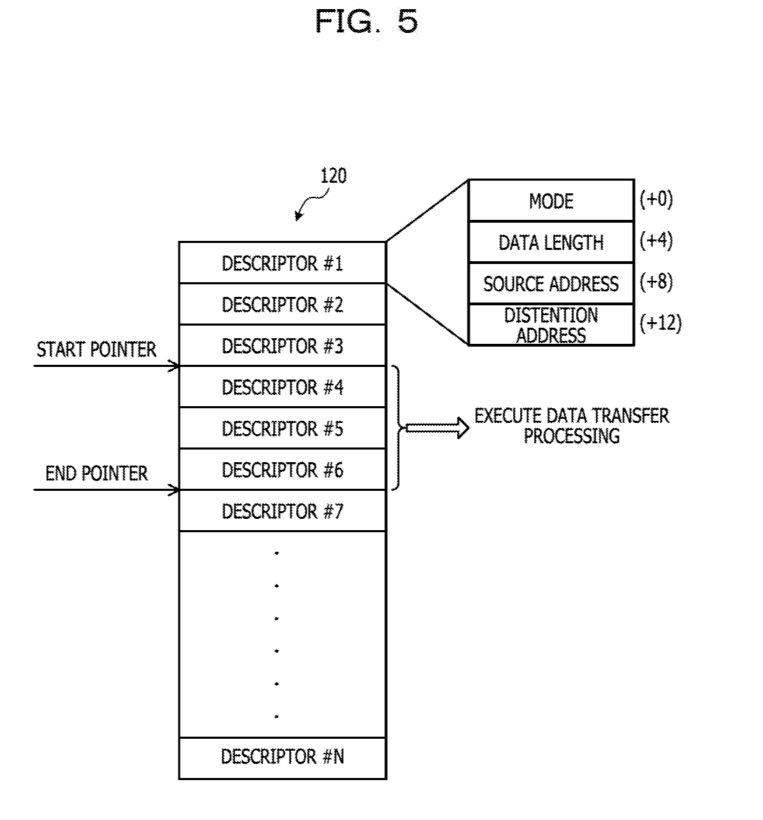

FIG. 5 is a diagram for explaining the descriptors. As illustrated in FIG. 5, for example, a mode, a data length, a source address, and a destination address are described in each of the descriptors.

The mode indicates processing types. As the modes, for example, there are a write mode which indicates the inter-CM write and a read mode which indicates the inter-CM read. The data length indicates the size of write-data or read-data. The source address indicates the transfer source address of data. The source address indicates the address of the RAM 102 in the write mode, and the address of the RAM 202 in the read mode. The destination address indicates the transfer destination address of data. The destination address indicates the address of the RAM 202 in the write mode, and the address of the RAM 102 in the read mode. In the embodiment, assume that the size of the descriptor is 16 bytes and each of the area sizes of the mode, the data length, the source address, and the destination address is 4 bytes.

As described above, the descriptor area 120, in which two or more descriptors are stored in the FIFO method, is allocated to the RAM 102. In the example of FIG. 5, the descriptor area 120 is configured to be able to retain N descriptors from descriptor #1 to descriptor #N. The descriptors are created by the CPU 101 and stored in the descriptor area 120. The descriptors stored in the descriptor area 120 are read by the descriptor read unit 111 of the DMA controller 110 and the content thereof is referred to.

The start pointer stored by the start pointer register 113 indicates the head position of the storage area for the descriptors of the descriptor area 120 yet to be read. The end pointer stored by the end pointer register 114 indicates the tail position of the storage area for the descriptors of the descriptor area 120 already read.

When the CPU 101 creates the descriptors and stores the thus-created descriptors in the descriptor area 120, the CPU 101 updates the end pointer such that the end pointer indicates the tail position of the storage area for the stored descriptors. This produces a difference between the start pointer and the end pointer. The descriptor read unit 111 of the DMA controller 110 reads in sequence the descriptors from the position indicated by the start pointer to the position indicated by the end pointer, and processes data transfer based on the read descriptors.

In the example of FIG. 5, descriptors #4 to #6 are started to be stored in the descriptor area 120 by the CPU 101 from the state where the start pointer and the end pointer indicate the tail position of descriptor #3. The end pointer is updated in sequence by the CPU 101 such that the end pointer indicates the tail position of descriptor #6. The descriptor read unit 111 first reads descriptor #4 based on the start pointer, and requests the transfer controller 112 to process data transfer based on descriptor #4. When this data transfer processing is completed, the descriptor read unit 111 increments the start pointer by one descriptor. Thereafter, the descriptor read unit 111 repeats the processing described above until the start pointer matches the end pointer. Thus, descriptors #5 and #6 are read in sequence, and the data transfer based on descriptors #5 and #6 is processed.

Note that the maximum value of the start pointer and the end pointer is the value which indicates the head position of the last descriptor in the descriptor area 120 (descriptor #N). In the case where the start pointer and the end pointer are further incremented by one descriptor from this position, the values of the start pointer and the end pointer return to the value which indicates the head position of the descriptor area 120 (head position of descriptor #1).

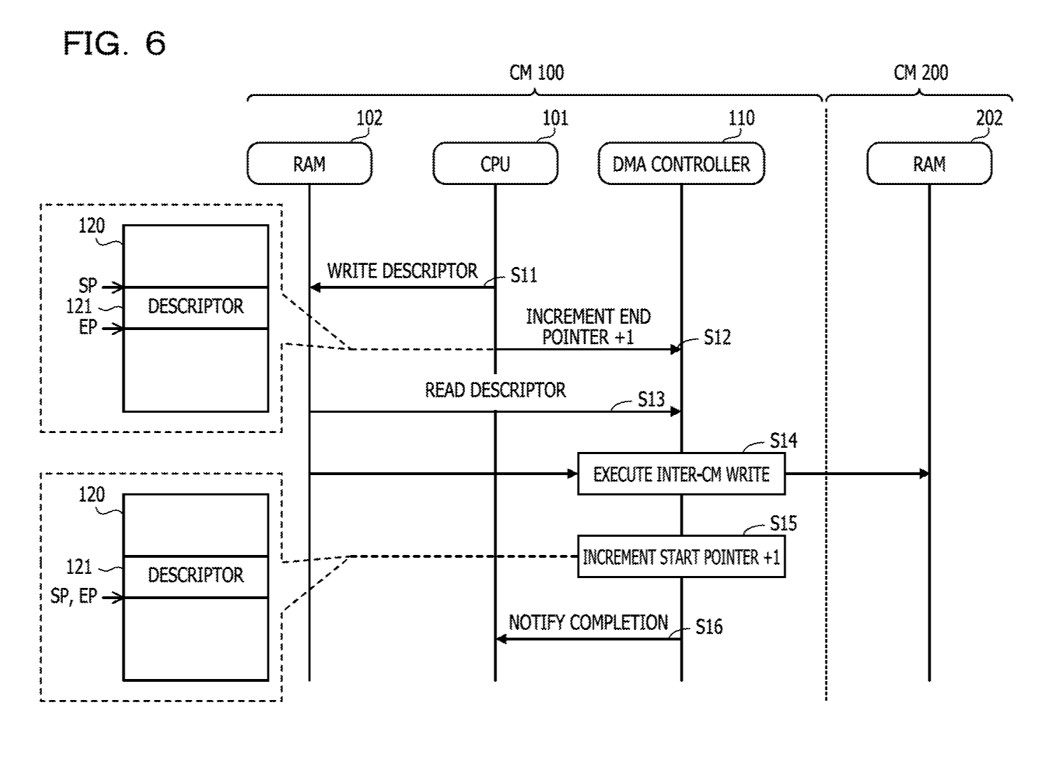

FIG. 6 is a sequence diagram illustrating an example of basic procedures of data transfer processing by the DMA controller. FIG. 6 illustrates procedures for write processing by the CM 200 onto the RAM 202 (inter-CM write), for example. Note that “SP” illustrated in FIG. 6 denotes the position of the descriptor area 120 indicated by the start pointer, and “EP” denotes the position of the descriptor area 120 indicated by the end pointer.

[Step S11] The CPU 101 creates a descriptor 121 in which a processing content of the inter-CM write is described, and writes the thus-created descriptor 121 onto the descriptor area 120.

[Step S12] The CPU 101 increments the end pointer in the end pointer register 114 by one descriptor. Thus, as illustrated in the upper left of FIG. 6, a difference equal to one descriptor is produced between the start pointer and the end pointer.

[Step S13] When the descriptor read unit 111 of the DMA controller 110 detects the difference produced between the start pointer and the end pointer, the descriptor read unit 111 reads the descriptor 121 from the position indicated by the start pointer.

[Step S14] The descriptor read unit 111 requests the transfer controller 112 to execute the inter-CM write based on the descriptor 121. The transfer controller 112 executes the thus-requested inter-CM write. To be more specific, the transfer controller 112 reads data from the RAM 102, transmits the data thus read to the DMA controller 210 of the CM 200 via the PCIe switch 331, and requests the DMA controller 210 to write the data onto the RAM 202 of the CM 200. Thus, the data is written onto the RAM 202.

[Step S15] When the inter-CM write by the transfer controller 112 is completed, the descriptor read unit 111 increments the start pointer in the start pointer register 113 by one descriptor. Thus, as illustrated in the lower left of FIG. 6, the start pointer is made to indicate the same position as that of the end pointer.

[Step S16] The descriptor read unit 111 notifies the CPU 101 of the completion of the data transfer processing based on the descriptor 121.

The above procedures make it possible for the CPU 101 to cause the DMA controller 110 to process data transfer between the RAM 102 and the RAM 202 by creating and storing the descriptor 121 and updating the end pointer. The CPU 101 is allowed to execute other processing in parallel while the data transfer is being processed by the DMA controller 110.

It is to be noted that after the inter-CM write is executed at Step S14 described above, the DMA controller 110 responds to the CPU 101 that the processing has terminated without checking whether or not the data has reached the CM 200. Accordingly, it is not possible for the CPU 101 to know whether or not the data has been correctly written onto the RAM 202 of the CM 200.

In the case where the host write is requested, for example, the inter-CM write is executed in order to mirror the write-data written onto the cache area of the RAM 102 to the RAM 202 of the CM 200. In this case, when the CPU 101 is notified by the DMA controller 110 that the inter-CM write of the write-data has terminated, the CPU 101 responds to the host device 410 that the host write has been completed normally even if the writing of the write-data has actually failed. Accordingly, if the operation of the CM 100 stops due to a fault, part of the data in the cache area is lost.

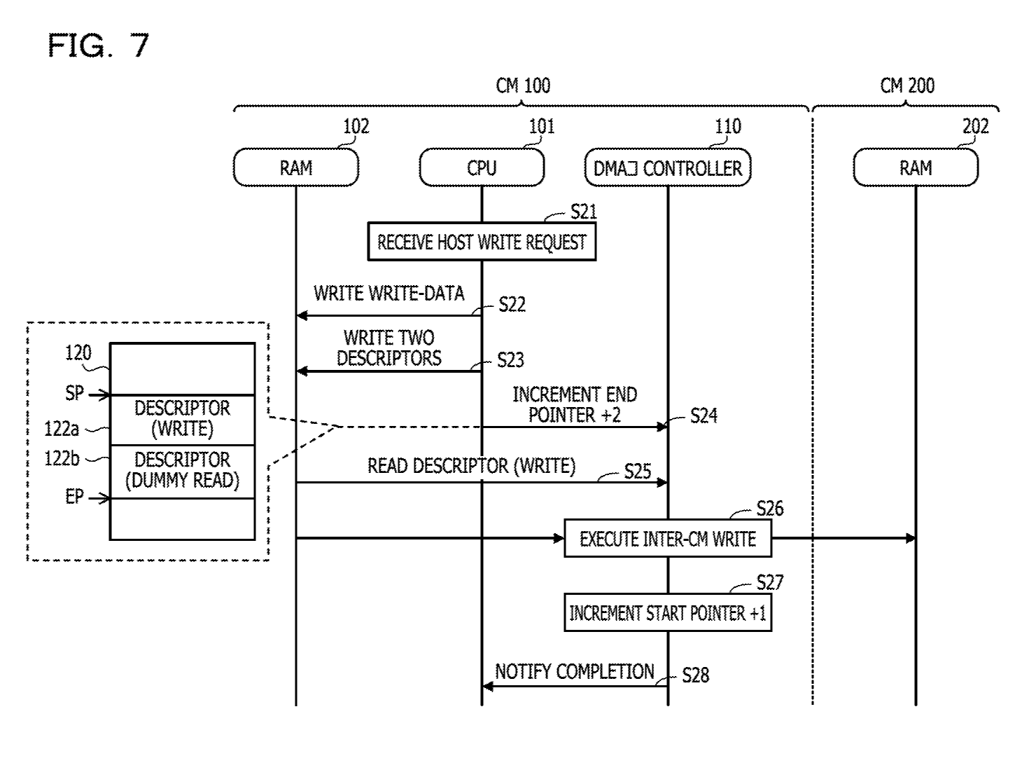

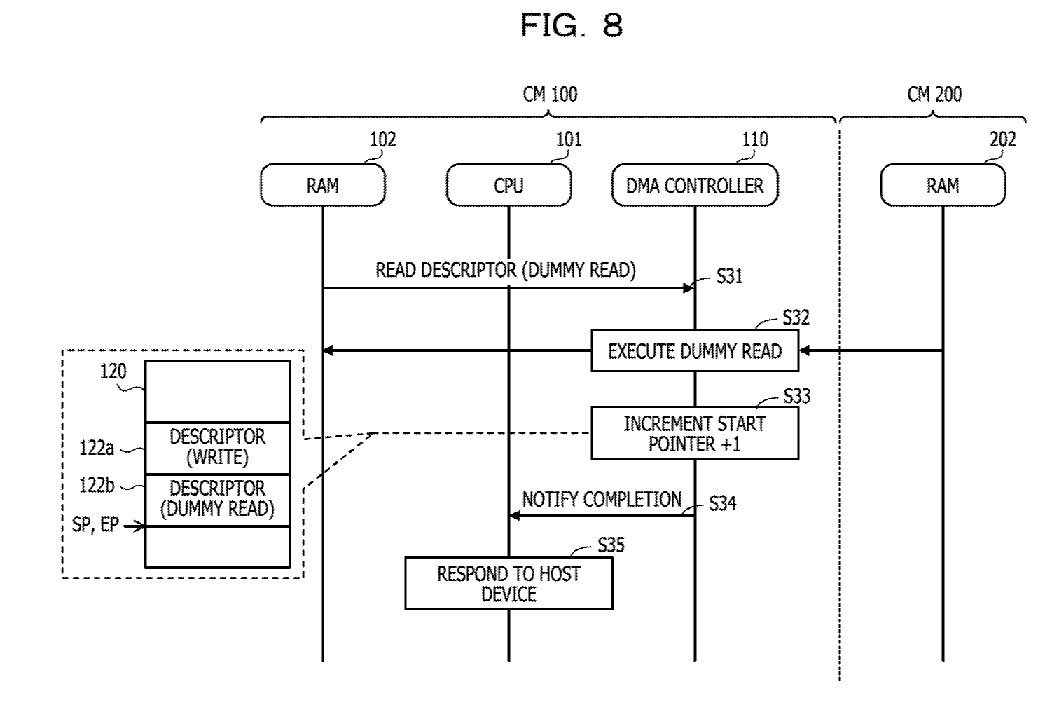

Given this situation, in order to check reception of the write-data, one may consider a method of executing the dummy read following the inter-CM write. The dummy read is processing for reading data from the predetermined same area on the RAM 202 of the CM 200. Here, as a comparative example, an example of processing procedures in the case where the dummy read is executed immediately after the inter-CM write will be described using FIGS. 7 and 8.

FIGS. 7 and 8 are each a sequence diagram illustrating the comparative example of the write processing procedures with the dummy read.

[Step S21] The host access controller 101a of the CPU 101 receives a host write request from the host device 410, for example. Also, the host access controller 101a receives the write-data from the host device 410, and stores the thus-received write-data in a buffer area of the RAM 102.

[Step S22] The host access controller 101a writes the write-data stored in the buffer area onto the cache area in the RAM 102.

[Step S23] The host access controller 101a creates a descriptor 122a in which a processing content of the inter-CM write is described, and a descriptor 122b in which a processing content of the dummy read is described. The inter-CM write of the former is processing for reading the received write-data from the RAM 102 and writing the write-data thus read onto the RAM 202 of the CM 200. The host access controller 101a writes in sequence the thus-created descriptors 122a and 122b onto the descriptor area 120.

[Step S24] The host access controller 101a increments the end pointer in the end pointer register 114 by two descriptors. Thus, as illustrated on the left side of FIG. 7, a difference equal to two descriptors is produced between the start pointer and the end pointer.

[Step S25] When the descriptor read unit 111 of the DMA controller 110 detects the difference produced between the start pointer and the end pointer, the descriptor read unit 111 reads the descriptor 122a from the position indicated by the start pointer.

[Step S26] The descriptor read unit 111 requests the transfer controller 112 to execute the inter-CM write based on the descriptor 122a. The transfer controller 112 executes the thus-requested inter-CM write. Hence, the received write-data is written onto the RAM 202.

[Step S27] When the inter-CM write by the transfer controller 112 is completed, the descriptor read unit 111 increments the start pointer in the start pointer register 113 by one descriptor. Thus, the start pointer is made to indicate the head position of the descriptor 122b for the dummy read.

[Step S28] The descriptor read unit 111 notifies the CPU 101 of the completion of the data transfer processing based on the descriptor 122a.

Subsequently, the processing of FIG. 8 is executed.

[Step S31] The descriptor read unit 111 reads the descriptor 122b from the position indicated by the start pointer.

[Step S32] The descriptor read unit 111 requests the transfer controller 112 to execute the dummy read based on the descriptor 122b. The transfer controller 112 executes the thus-requested dummy read. Hence, dummy data is read from a predetermined area of the RAM 202 of the CM 200 and is written onto a predetermined area of the RAM 102.

[Step S33] When the dummy read by the transfer controller 112 is completed, the descriptor read unit 111 increments the start pointer in the start pointer register 113 by one descriptor. Thus, as illustrated on the left side of FIG. 8, the start pointer is made to indicate the same position as that of the end pointer.

[Step S34] The descriptor read unit 111 notifies the CPU 101 of the completion of the data transfer processing based on the descriptor 122b.

[Step S35] The host access controller 101a of the CPU 101 recognizes with the notification at Step S34 that the dummy read has been executed normally, and responds to the host device 410 that the host write has been completed normally.

In the above processing, it is not possible for the DMA controller 110 to receive the dummy data in the case where, at the time of execution of the dummy read, there is an abnormality in a circuit (for example, the DMA controller 210) on a path of the dummy data in the CM 200. Accordingly, based on whether or not the dummy data is receivable, the DMA controller 110 may deduce whether or not there is an abnormality in a circuit on a path of the write-data in the CM 200 at least at the time of execution of the inter-CM write immediately before. In the case where the dummy data is received, the DMA controller 110 may deduce it is highly possible that the inter-CM write immediately before has been executed normally. As described above, from whether or not the dummy read has been executed, it is possible to provisionally determine with a high possibility whether or not the write-data has been received at the inter-CM write immediately before.

In addition, in the dummy read, predetermined data is read from a predetermined area on the RAM 202, as described above. Accordingly, it is possible to stably make small the size of the data to be read compared to, for example, the file read processing in which the write-data transferred at the inter-CM write is immediately read from the RAM 202. Hence, it is possible to reduce the processing load for checking the reception and to shorten the processing time, and as a result to shorten the response time to the host write request.

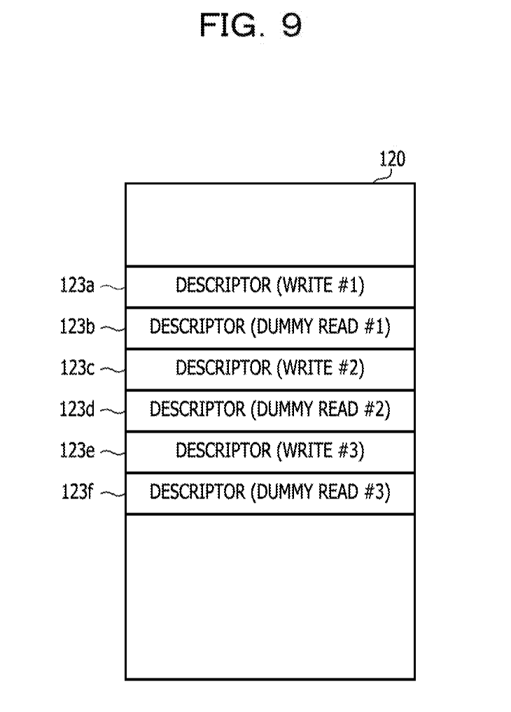

FIG. 9 is a diagram illustrating an example of creating the descriptors in the case where the host write is successively requested. In the case where the processing of the comparative example illustrated in FIGS. 7 and 8 is executed, the CPU 101 creates both of the descriptor for the inter-CM write and the descriptor for the dummy read each time the host write is requested. Accordingly, in the case where host write is successively requested, those two types of descriptors are generated on each occasion and are stored in sequence in the descriptor area 120.

FIG. 9 illustrates an example of the descriptors created in the case where the host write is successively requested three times. In this example, a descriptor 123a for the inter-CM write corresponding to the first host write and a descriptor 123b for the dummy read, a descriptor 123c for the inter-CM write corresponding to the second host write and a descriptor 123d for the dummy read, and a descriptor 123e for the inter-CM write corresponding to the third host write and a descriptor 123f for the dummy read are created.

Here, as described above, the dummy read is processing for reading the same data from the same address in the RAM 202. Thus, all descriptors for the dummy read have the same content. When the descriptors with the same content as above are repeatedly created each time the host write request is received, there arises a problem of deteriorating the processing efficiency of the CPU 101.

Given this situation, in the embodiment, a descriptor dedicated for executing the dummy read (shared descriptor) is stored in advance in the shared descriptor area 130 of the RAM 102. Meanwhile, the CPU 101 does not create the descriptors for the dummy read as in the comparative example described above, but creates the descriptor dedicated for executing read of the shared descriptor. The size of the descriptor for reading the shared descriptor is made smaller than that of the descriptor for the dummy read as in the comparative example. Thus, the time taken by the CPU 101 to create the descriptors is shortened, and thereby the processing efficiency of the CPU 101 is improved.

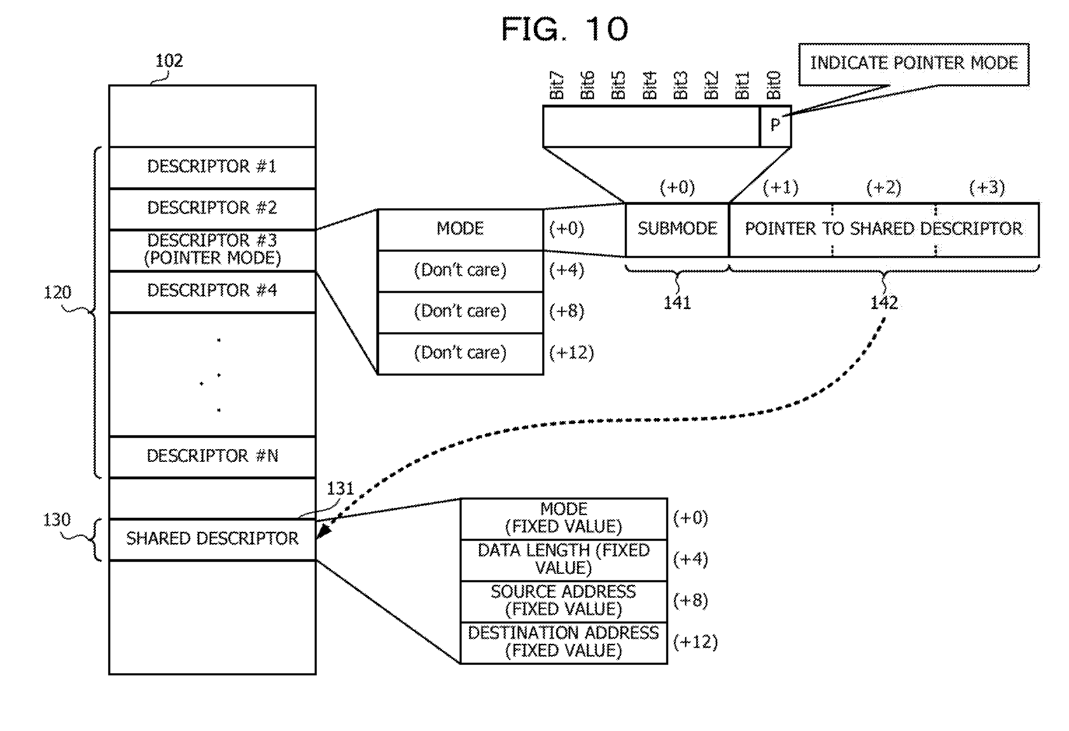

FIG. 10 is a diagram for explaining how the dummy read is executed in the second embodiment. In the RAM 102, the shared descriptor area 130 is allocated separately from the descriptor area 120, as described above. A shared descriptor 131 for executing the dummy read is stored in advance in the shared descriptor area 130.

The size and the data structure of the shared descriptor 131 are the same as those of the descriptors for the inter-CM write and the inter-CM read. In other words, each of the mode, the data length, the source address, and the destination address is described in the shared descriptor 131 as 4-byte data. Note that each set of data described in the shared descriptor 131 is a predetermined fixed value. The read mode indicating the inter-CM read is set as the mode. The data length indicates the size of the dummy data. The address of the storage area for the dummy data in the RAM 202 of the CM 200 is set as the source address. The address of the predetermined area for the RAM 102 of the CM 100 is set as the destination address.

In the case where the dummy read is executed, the CPU 101 creates a descriptor in which a pointer mode is set as the mode. The pointer mode is not an operating mode in which the inter-CM write and the inter-CM read are performed based on the descriptor, but an operating mode in which the shared descriptor 131 is read based on the pointer set in the descriptor. In the example of FIG. 10, the pointer mode is set in descriptor #3 stored in the descriptor area 120. Hereinbelow, a descriptor in which the pointer mode is set is simply described as a “descriptor in the pointer mode”.

In a descriptor in the pointer mode, the mode area is divided into a 1-byte submode area 141 and a 3-byte pointer area 142. A bit value, which indicates that the pointer mode is set, is set to one bit in the submode area 141. Hence, it is possible for the descriptor read unit 111 of the DMA controller 110 to know that the pointer mode is set to the read descriptor by referring to the submode area 141.

A pointer which indicates the head position of the storage area for the shared descriptor 131 in the RAM 102 is set in the pointer area 142. This pointer is set as a numerical value stored within the 3-byte pointer area 142. In the embodiment, the pointer is set as an addition value to the base address, and thereby the number of bits of the pointer is set smaller than the physical address on the RAM 102. As an example of another method, the shared descriptor 131 may be stored in a storage area near the head on the RAM 102, and a value with most significant bits of the physical address of the storage area omitted may be set as a pointer. In other words, unlike the RAM 202 outside the device, the RAM 102 is a local storage device inside the device. Thus, it is easy to conceive various methods of making the number of bits of information on the position indicating the fixed storage area in the RAM 102 smaller than the physical address.

In the area of the descriptor in the pointer mode other than that for the mode (area corresponding to the data length, the source address, and the destination address), no data is stored. In other words, the size of the descriptor in the pointer mode is smaller than that of the descriptor in the read mode or the write mode, or the shared descriptor 131. Accordingly, it is possible for the CPU 101 to create the descriptor in the pointer mode in a period of time shorter than that for the descriptor in the read mode or the write mode, or the shared descriptor 131.

Note that, for example, the physical address of the shared descriptor 131, instead of the pointer, may be set in the descriptor in the pointer mode. In this case as well, it is possible to make small the size of the descriptor in the pointer mode compared to other descriptors in which two physical addresses are set, namely, the source address and the destination address.

When the descriptor read unit 111 of the DMA controller 110 recognizes that the pointer mode is set in the descriptor read from the RAM 102 based on the start pointer, the descriptor read unit 111 reads the shared descriptor 131 from the storage area indicated by the pointer set in the pointer area 142. Then, the descriptor read unit 111 executes the dummy read based on the shared descriptor 131 thus read.

As described above, in the embodiment, a system is provided in which the shared descriptor 131 for executing the dummy read is read based on the descriptor in the pointer mode. Meanwhile, only information indicating a predetermined one area may be set in the descriptor in the pointer mode as the information indicating the storage area. Thus, it is possible to make small the size of the descriptor in the pointer mode. Accordingly, the processing time of the CPU 101 to request the execution of the dummy read is shortened. As a result, the processing load of the CPU 101 is reduced, and the processing efficiency thereof is improved.

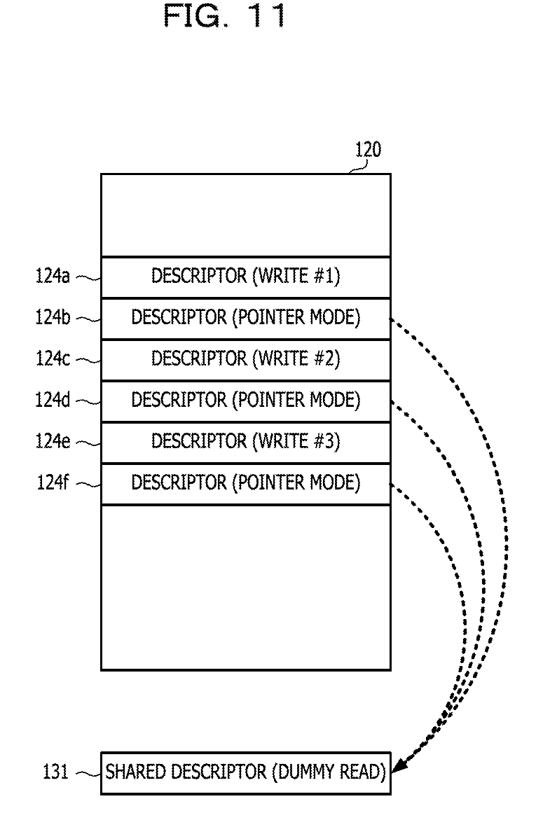

FIG. 11 is a diagram illustrating an example of creating the descriptors in a case where the host write is successively requested in the second embodiment. As in the example of FIG. 9, FIG. 11 illustrates an example of the descriptors created in the case where the host write is successively requested three times.

In FIG. 11, after a descriptor 124a for the inter-CM write corresponding to the first host write, a descriptor 124b in the pointer mode is created. In addition, after a descriptor 124c for the inter-CM write corresponding to the second host write, a descriptor 124d in the pointer mode is created. Moreover, after a descriptor 124e for the inter-CM write corresponding to the third host write, a descriptor 124f in the pointer mode is created. All of the pointers set in the respective descriptors 124b, 124d, and 124f indicate the shared descriptor 131 for the dummy read.

The sizes of the descriptors 124b, 124d, and 124f in FIG. 11 are smaller than those of the descriptors 123b, 123d, and 123f for the dummy read in FIG. 9. Accordingly, the time taken by the CPU 101 to create the descriptors 124b, 124d, and 124f is shortened. Hence, the more host writes are successively requested as in FIG. 11, the more greatly the processing load of the CPU 101 may be reduced.

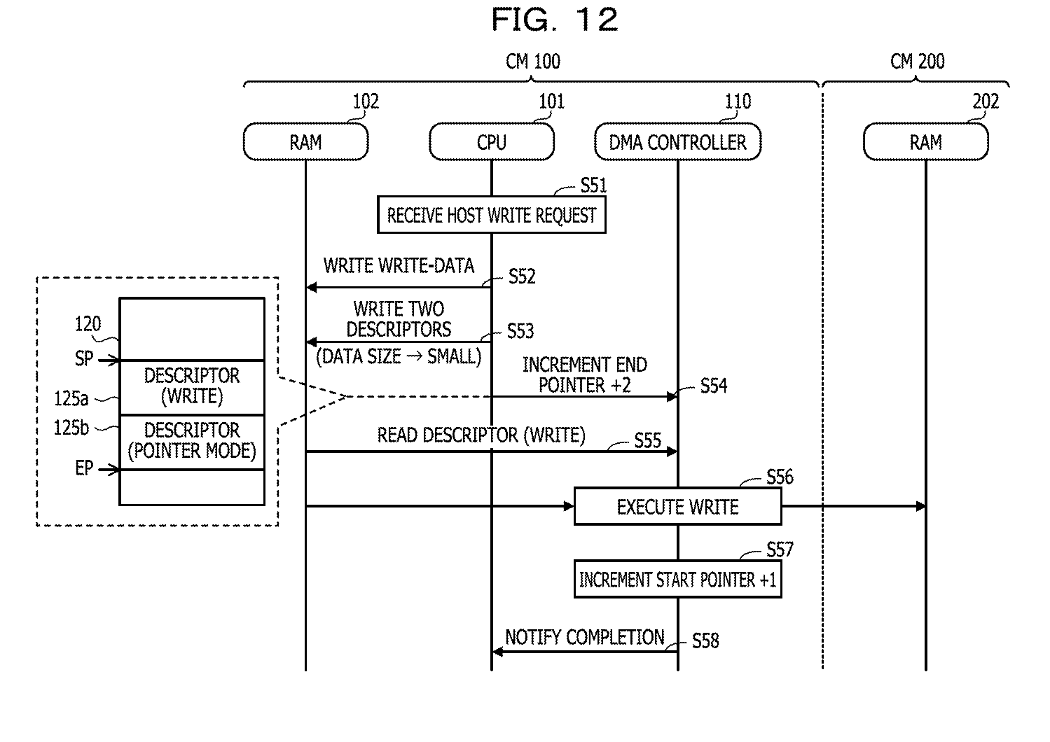

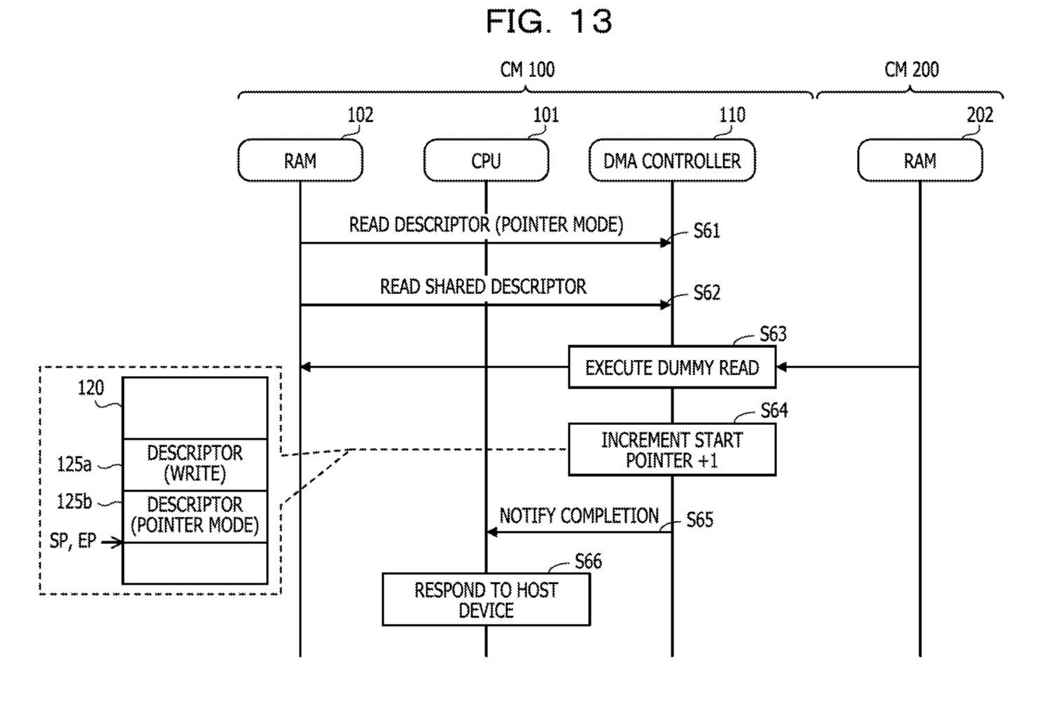

FIGS. 12 and 13 are each a sequence diagram illustrating an example of processing procedures in the case where the host write is requested.

[Step S51] The host access controller 101a of the CPU 101 receives the host write request from the host device 410, for example. Also, the host access controller 101a receives the write-data from the host device 410, and stores the thus-received write-data in the buffer area of the RAM 102.

[Step S52] The host access controller 101a writes the write-data stored in the buffer area onto the cache area in the RAM 102.

[Step S53] The host access controller 101a creates a descriptor 125a in which a processing content of the inter-CM write is described, and a descriptor 125b in the pointer mode. The host access controller 101a writes in sequence the thus-created descriptors 125a and 125b in the descriptor area 120.

[Step S54] The host access controller 101a increments the end pointer in the end pointer register 114 by two descriptors. Thus, as illustrated on the left side of FIG. 12, a difference equal to two descriptors is produced between the start pointer and the end pointer.

[Step S55] When the descriptor read unit 111 of the DMA controller 110 detects the difference produced between the start pointer and the end pointer, the descriptor read unit 111 reads the descriptor 125a from the position indicated by the start pointer.

[Step S56] The descriptor read unit 111 requests the transfer controller 112 to execute the inter-CM write based on the descriptor 125a. The transfer controller 112 executes the thus-requested inter-CM write. Hence, the received write-data is written onto the RAM 202.

[Step S57] When the inter-CM write by the transfer controller 112 is completed, the descriptor read unit 111 increments the start pointer in the start pointer register 113 by one descriptor. Thus, the start pointer is made to indicate the head position of the descriptor 125b in the pointer mode.

[Step S58] The descriptor read unit 111 notifies the CPU 101 of the completion of the data transfer processing based on the descriptor 125a.

Subsequently, the processing of FIG. 13 is executed.

[Step S61] The descriptor read unit 111 reads the descriptor 125b from the position indicated by the start pointer.

[Step S62] The descriptor read unit 111 reads the shared descriptor 131 from the storage area in the RAM 102 indicated by the pointer set in the descriptor 125b.

[Step S63] The descriptor read unit 111 requests the transfer controller 112 to execute the dummy read based on the shared descriptor 131. The transfer controller 112 executes the thus-requested dummy read. Hence, dummy data is read from a predetermined area of the RAM 202 of the CM 200 and is written onto a predetermined area of the RAM 102.

In the case where the dummy data is successfully read from the RAM 202 at Step S63, the descriptor read unit 111 executes the following processing at Step S64.

[Step S64] When the dummy read by the transfer controller 112 is completed, the descriptor read unit 111 increments the start pointer in the start pointer register 113 by one descriptor. Thus, as illustrated on the left side of FIG. 13, the start pointer is made to indicate the same position as that of the end pointer.

[Step S65] The descriptor read unit 111 notifies the CPU 101 of the completion of the data transfer processing based on the descriptor 125b.

[Step S66] The host access controller 101a of the CPU 101 recognizes with the notification at Step S65 that the dummy read has been executed normally, and responds to the host device 410 that the host write has been completed normally.

Subsequently, the processing of the CM 100 will be described using flowcharts.

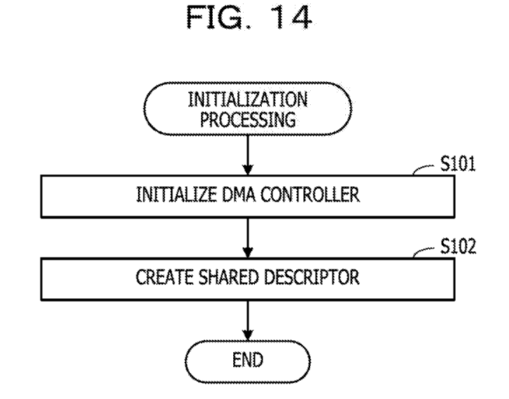

FIG. 14 is a flowchart illustrating an example of initialization processing of the DMA controller. The processing of FIG. 14 is executed when, for example, the CM 100 is activated by turning on the power.

[Step S101] The CPU 101 initializes the DMA controller 110.

[Step S102] The CPU 101 creates the shared descriptor 131 for executing the dummy read, and stores the thus-created shared descriptor 131 in a predetermined storage area in the RAM 102.

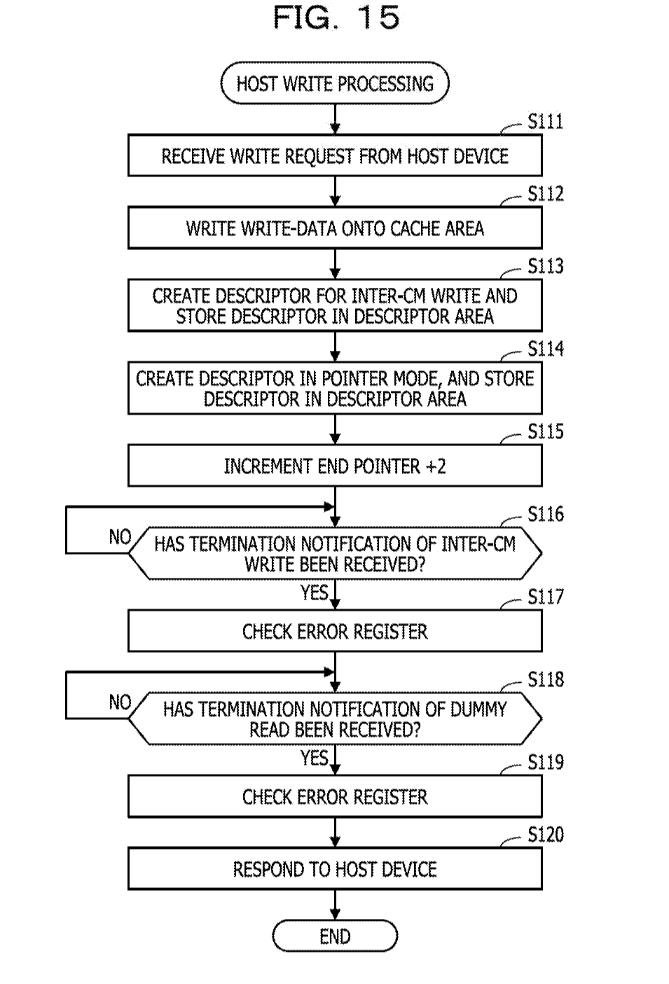

FIG. 15 is a flowchart illustrating an example of processing of the CPU in the case where the host write is requested. Here, in FIG. 15, assume that the host write is requested from the host device 410, for example.

[Step S111] The host access controller 101a receives the host write request from the host device 410. Also, the host access controller 101a receives the write-data from the host device 410, and stores the thus-received write-data in the buffer area of the RAM 102.

[Step S112] The host access controller 101a writes the write-data stored in the buffer area onto the cache area in the RAM 102.

[Step S113] The host access controller 101a creates the descriptor in which a processing content of the inter-CM write is described, and stores the thus-created descriptor in the descriptor area 120. In the created descriptor, the processing content of reading the write-data stored in the buffer area and writing the write-data thus read onto the RAM 202 of the CM 200 is described.

[Step S114] The host access controller 101a creates the descriptor in the pointer mode, and stores the thus-created descriptor in the descriptor area 120.

[Step S115] The host access controller 101a increments the end pointer in the end pointer register 114 by two descriptors.

[Step S116] The host access controller 101a determines whether or not the host access controller 101a has received a termination notification of the inter-CM write from the DMA controller 110. This termination notification is made, for example, through an interrupt by the DMA controller 110. The determination at Step S116 is made at definite time intervals. When the host access controller 101a receives the termination notification, the processing proceeds to Step S117.

[Step S117] The host access controller 101a reads the content of the error register 116 to check whether or not an error has occurred. Here, in an actual situation, although not illustrated, in the case where no error has occurred, the processing proceeds to Step S118, and in the case where an error has occurred, the host access controller 101a notifies the host device 410 of the failure of execution of the host write, and terminates the processing.

[Step S118] The host access controller 101a determines whether or not the host access controller 101a has received the termination notification of the dummy read from the DMA controller 110. This termination notification is made, for example, through an interrupt by the DMA controller 110. The determination at Step S118 is made at definite time intervals. When the host access controller 101a receives the termination notification, the processing proceeds to Step S119.

[Step S119] The host access controller 101a reads the content of the error register 116 to check whether or not an error has occurred.

[Step S120] The host access controller 101a responds to the host device 410. In the case where no error has occurred, the host access controller 101a notifies the host device 410 that the host write has been completed normally. In the case where an error has occurred, on the other hand, the host access controller 101a notifies the host device 410 that the host write has not been completed normally.

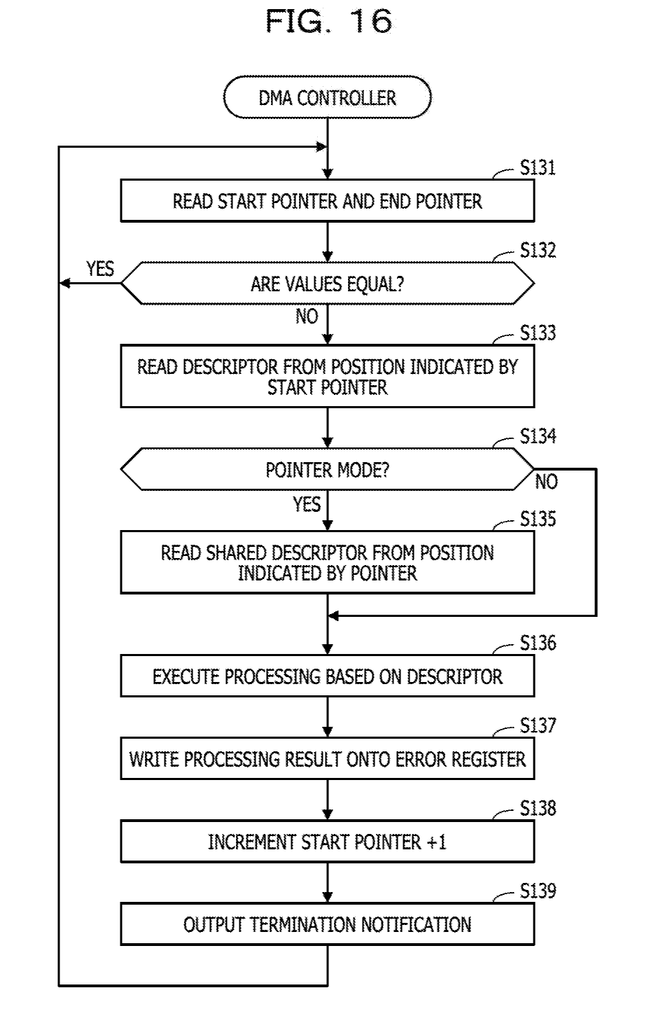

FIG. 16 is a flowchart illustrating an example of processing of the DMA controller.

[Step S131] The descriptor read unit 111 reads the start pointer and the end pointer from the start pointer register 113 and the end pointer register 114, respectively.

[Step S132] The descriptor read unit 111 compares the start pointer and the end pointer which are read at Step S131. In the case where the values of the start pointer and the end pointer are different, the descriptor read unit 111 executes the processing at Step S133. On the other hand, in the case where the values of the start pointer and the end pointer are the same, the descriptor read unit 111 executes the processing at Step S131 after a certain period of time.

[Step S133] The descriptor read unit 111 reads the descriptor from the position indicated by the start pointer in the descriptor area 120.

[Step S134] The descriptor read unit 111 determines whether or not the pointer mode is set in the mode area of the read descriptor. In the case where the pointer mode is set, the descriptor read unit 111 executes the processing at Step S135. In the case where the pointer mode is not set, the descriptor read unit 111 executes the processing at Step S136.

[Step S135] The descriptor read unit 111 reads the shared descriptor 131 from the position of the shared descriptor area 130 indicated by the pointer set in the read descriptor.

[Step S136] The descriptor read unit 111 requests the transfer controller 112 to process data transfer based on the descriptor. The descriptor referred to at this moment is the shared descriptor 131 read at Step S135 in the case of “Yes” at Step S134, and is the descriptor read at Step S133 in the case of “No” at Step S134. The transfer controller 112 executes the requested data transfer processing.

[Step S137] The transfer controller 112 notifies the descriptor read unit 111 of the result of data transfer processing. The descriptor read unit 111 writes the success or failure of the data transfer processing onto the error register 116 based on the content of the notification.

[Step S138] The descriptor read unit 111 increments the start pointer in the start pointer register 113 by one descriptor.

[Step S139] The descriptor read unit 111 outputs a termination notification of the data transfer processing to the CPU 101. This output is executed through, for example, an interrupt.

Thereafter, the processing returns to Step S131.

In the second embodiment described above, the size of the descriptors created by the CPU 101 to instruct the execution of the dummy read may be made small. Accordingly, it is possible to shorten the processing time of the CPU 101 to instruct the execution of the dummy read and to reduce the processing load thereof compared to the case where the shared descriptor 131 is created each time the execution of the dummy read is instructed.

The processing functions of the devices (storage controller 10, CMs 100 and 200) presented in the embodiments described above may be implemented using a computer. In that case, a program is provided which describes the processing content of the function to be possessed by each of the devices. The above-described functions are implemented on the computer by executing the program using the computer. The program which describes the processing content may be recorded on a computer-readable recording medium. Examples of the computer-readable recording medium are a magnetic storage device, an optical disc, a magneto-optical recording medium, and a semiconductor memory. The magnetic storage device includes a hard disk device (HDD), a flexible disk (FD), and a magnetic tape. The optical disc includes a digital versatile disc (DVD), a DVD-RAM, a compact disc-read only memory (CD-ROM), and a compact disc-recordable (CD-R)/-rewritable (CD-RW). The magneto-optical recording medium includes a magneto-optical (MO) disk.

In the case of circulating the program, portable recording media, such as the DVD and the CD-ROM, on which the program is recorded are sold, for example. Alternatively, it is possible to store the program on the storage device of a server computer and to transfer the program to another computer from the server computer via a network.

The computer which executes the program stores in its storage device the program recorded on the portable recording medium or the program transferred from the server computer, for example. Then, the computer reads the program from its storage device and executes the processing according to the program. Note that the computer may read the program directly from the portable recording medium and execute the processing according to the program. In addition, each time the program is transferred from the server computer coupled via the network, the computer may execute one after another the processing according to the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first memory;
a data transfer circuit; and
a processor coupled to the memory and the data transfer circuit, wherein
the first memory is configured to store a first read instruction to read second data stored in a second memory,
the processor is configured to generate a first write instruction to write first data stored in the first memory into the second memory and a second read instruction to read the first read instruction stored in the first memory, and
the data transfer circuit is configured to:
write the first data into the second memory based on the first write instruction,
read, after the first data is written, the second data from the second memory by executing the first read instruction stored in the first memory based on the second read instruction, and
transmit, after the second data is read, to the processor a notification indicating that the second data has been read.

2. The information processing apparatus according to claim 1, wherein
the first memory is further configured to store a first instruction set including a first address of the second data in the second memory and the first read instruction.

3. The information processing apparatus according to claim 2, wherein
the processor is further configured to generate a second instruction set including a second address of the first instruction set in the first memory and the second read instruction.

4. The information processing apparatus according to claim 3, wherein
the data transfer circuit is further configured to read the first instruction set from the first memory based on the second address included in the second instruction set.

5. The information processing apparatus according to claim 3, wherein
the first instruction set includes a transfer destination address of the second data.

6. The information processing apparatus according to claim 3, further comprising:
a third memory configured to store the first write instruction and the second instruction set, wherein
the data transfer circuit is further configured to:
read the first write instruction from the third memory,
write the first data into the second memory based on the first write instruction,
read, after the first data is written, the second instruction set from the third memory, and
read the first instruction set from the first memory based on the second instruction set.

7. The information processing apparatus according to claim 3, wherein
the first memory includes a cache area,
the second memory includes a mirror cache area corresponding to the cache area, and
the processor is further configured to:
receive a data write request and write data from an information processing device,
write the write data into the cache area,
generate a second write instruction to write the write data into the mirror cache area, and
transmit a completion response to the write request to the information processing device after the write data is written into the cache area and the notification is received from the data transfer circuit.

8. The information processing apparatus according to claim 1, wherein
the data transfer circuit is a direct memory access controller.

9. A method of transferring data executed by an information processing apparatus including a first memory, a data transfer circuit, and a processor coupled to the memory and the data transfer circuit, the method comprising:
storing, in the first memory, a first read instruction to read second data stored in a second memory;
generating, by the processor, a first write instruction to write first data stored in the first memory into the second memory and a second read instruction to read the first read instruction stored in the first memory;
writing, by the data transfer circuit, the first data into the second memory based on the first write instruction;
reading, after the first data is written, by the data transfer circuit, the second data from the second memory by executing the first read instruction stored in the first memory based on the second read instruction; and
transmitting, after the second data is read, by the data transfer circuit, to the processor a notification indicating that the second data has been read.

10. The method according to claim 9 further comprising:
in the storing of the first read instruction, storing, into the first memory, a first instruction set including a first address of the second data in the second memory and the first read instruction.

11. The method according to claim 10 further comprising:
generating, by the processor, a second instruction set including a second address of the first instruction set in the first memory and the second read instruction.

12. The method according to claim 11 further comprising:
reading, by the data transfer circuit, the first instruction set from the first memory based on the second address included in the second instruction set.

13. The method according to claim 11, wherein
the first instruction set further includes a transfer destination address of the second data.

14. The method according to claim 11 further comprising:
storing, into a third memory, the first write instruction and the second instruction set;
reading, by the data transfer circuit, the first write instruction from the third memory;
writing, by the data transfer circuit, the first data into the second memory based on the first write instruction;
reading, by the data transfer circuit, after the first data is written, the second instruction set from the third memory; and
reading, by the data transfer circuit, the first instruction set from the first memory based on the second instruction set.

15. The method according to claim 11, wherein
the first memory includes a cache area,
the second memory includes a mirror cache area corresponding to the cache area, and the method further comprises:
receiving, by the processor, a data write request and write data from an information processing device;
writing, by the processor, the write data into the cache area;
generating, by the processor, a second write instruction to write the write data into the mirror cache area; and
transmitting a completion response to the write request to the information processing device after the write data is written into the cache area and the notification is received from the data transfer circuit.

16. The method according to claim 9, wherein
the data transfer circuit is a direct memory access controller.

17. A non-transitory computer-readable storage medium storing a program that causes an information processing apparatus to execute a process, the information processing apparatus including a first memory, a data transfer circuit, and a processor coupled to the memory and the data transfer circuit, the process comprising:
storing, in the first memory, a first read instruction to read second data stored in a second memory;
generating, by the processor, a first write instruction to write first data stored in the first memory into the second memory and a second read instruction to read the first read instruction stored in the first memory;
writing, by the data transfer circuit, the first data into the second memory based on the first write instruction;
reading, after the first data is written, by the data transfer circuit, the second data from the second memory by executing the first read instruction stored in the first memory based on the second read instruction; and
transmitting, after the second data is read, by the data transfer circuit, to the processor a notification indicating that the second data has been read.

18. The non-transitory computer-readable storage medium according to claim 17, the process further comprising:
in the storing of the first read instruction, storing, into the first memory, a first instruction set including a first address of the second data in the second memory and the first read instruction.

19. The non-transitory computer-readable storage medium according to claim 17, the process further comprising:
generating, by the processor, a second instruction set including a second address of the first instruction set in the first memory and the second read instruction.

20. The non-transitory computer-readable storage medium according to claim 19, the process further comprising:
reading, by the data transfer circuit, the first instruction set from the first memory based on the second address included in the second instruction set.
